(19) United States
(12) Patent Application Publication
(10) Pub. No.: US 2006/0248886 A1
(43) Pub. Date: Nov. 9, 2006

(54) Isothermal reciprocating machines

(76) Inventor: Thomas Tsoi Hei Ma, Essex (GB)

Correspondence Address: SALTAMAR INNOVATIONS, 30 FERN LANE, SOUTH PORTLAND, ME, 04106, US

(21) Appl. No.: 10/540,055

(22) PCT Filed: Dec. 23, 2003
(86) PCT No.: PCT/GB03/05713

§ 371 Date: Jun. 22, 2005

(30) Foreign Application Priority Data
Dec. 24, 2002 (GB) 0230132.3
Jan. 6, 2003 (GB) 0300112.0
Jan. 6, 2003 (GB) 0300136.9
Jan. 6, 2003 (GB) 0300134.4
Jan. 13, 2003 (GB) 0300615.2
Jan. 20, 2003 (GB) 0301221.8
Jan. 20, 2003 (GB) 0301222.6
Jan. 20, 2003 (GB) 0301215.0
Feb. 3, 2003 (GB) 0302342.1

(51) Int. Cl. F02G 1/04

(52) U.S. Cl. 60/517

(57) ABSTRACT

A reciprocating gas compressor is described operating according to an extended cycle of 4,6 or more strokes, wherein the first two strokes are sequential induction and compression strokes using a low pressure gas as working fluid and compressing it to a high pressure gas, and the remaining strokes are pairs of sequential filling and emptying strokes using more of the low pressure gas as heat transfer fluid for transferring heat from inside the gas compressor to outside the gas compressor. The gas compressor also contains an in-cylinder heat regenerator for absorbing heat from the compressed gas and releasing heat to the heat transfer fluid thus achieving near-isothermal compression. Using parallel principles, a reciprocating gas expander is also described for achieving near-isothermal expansion. Also described are reciprocating machines using the near-isothermal gas compressor and near-isothermal gas expander in combination according to the Ericsson heat engine cycle, the Stirling heat engine cycle and the Stirling refrigeration cycle.

### FIELD OF THE INVENTION

The present invention relates to reciprocating machines capable of near-isothermal compression and expansion.

### BACKGROUND OF THE INVENTION

The reciprocating gas compressor has been used extensively throughout industry for compressing gases to high pressure. Applications include a wide spectrum from heavy duty units in gas and oil fields, power generation plants, gas separation plants, chemical processing plants, refrigeration and gas liquefaction plants, manufacturing and production plants, construction industry etc, to light duty units for automotive, laboratory and domestic uses. In many cases, the energy cost of gas compression is a major factor determining the economics of the process or the plant. This in turn depends on the efficiency of the compressor.

The efficiency of the compressor typically lies between a lower limit where the compression process is adiabatic and an upper limit where the compression process is isothermal, the latter being the ideal efficiency. One objective of the present invention is to provide a reciprocating machine in which the compression process is as close to isothermal as possible.

As a corollary to the gas compressor, the ideal efficiency of a gas expander is achieved with isothermal expansion. Another objective of the present invention is to provide a reciprocating machine in which the expansion process is as close to isothermal as possible.

As further objectives, the invention includes reciprocating machines using the near-isothermal gas: compressor and near-isothermal gas expander in combination according to the Ericsson heat engine cycle, the Stirling heat engine cycle and the Stirling refrigeration cycle.

### SUMMARY OF THE INVENTION

According to a first aspect of the present invention, there is provided a reciprocating gas compressor operating according to an extended cycle of 4, 6 or more strokes, wherein the first two strokes are sequential induction and compression strokes using a low pressure gas as working fluid and compressing it to a high pressure gas, and the remaining strokes are pairs of sequential filling and emptying strokes using more of the low pressure gas as heat transfer fluid for transferring heat from inside the gas compressor to outside the gas compressor.

According to a second aspect of the present invention, there is provided a reciprocating gas expander operating according to an extended cycle of 4, 6 or more strokes, wherein the first two strokes are sequential expansion and exhaust strokes using a high pressure gas as working fluid to produce power, and the remaining strokes are pairs of sequential filling and emptying strokes using warm air or warmed exhaust gas as heat transfer fluid for transferring heat from outside the expander to inside the gas expander.

In the first aspect of the invention, the reciprocating gas compressor comprises at least one cylinder having a variable volume defined by a reciprocating piston which draws gas (working fluid) from a low pressure gas source into the cylinder during the induction stroke and compresses the gas to a high pressure before the gas is released to a high pressure gas reservoir during the compression stroke, characterised in that the reciprocating gas compressor is operated according to an extended cycle comprising after the said induction and compression strokes, at least one pair of extra strokes each pair consisting of a filling stroke in which more gas (heat transfer fluid) from the low pressure gas source is drawn by the piston into the cylinder to fill the cylinder followed immediately by an emptying stroke in which the filled gas is expelled by the piston out of the cylinder back to the low pressure gas source, such that the filled heat transfer gas cools the cylinder and piston and lowers the gas compressor temperature close to the temperature of the filled gas during the extra strokes, before the extended cycle is repeated with the working fluid of fresh low pressure gas inducted into the cylinder and compressed during the next compression stroke.

An open matrix heat regenerator constructed in fine mesh or thin wall cell structure of high heat capacity material is additionally provided occupying the clearance space in the cylinder and in intimate thermal contact with the gas inside the cylinder. The heat regenerator serves efficiently to absorb and store heat from the compressed gas during the compression stroke, and to release the stored heat to the filled gas during the extra filling and emptying strokes of the extended cycle.

In the invention, by using the low pressure gas also as heat transfer fluid to transfer heat away from the cylinder, piston and heat regenerator and lower the temperature of the cylinder and heat regenerator close to the temperature of the low pressure gas source during the extra filling and emptying strokes, the compressed gas during the next compression stroke will be cooled progressively by the heat regenerator and stay at substantially the same temperature as the heat regenerator, thus enabling the compressed gas in the gas compressor to achieve a compression process which is near-isothermal.

The invention supports near-isothermal compression by relaying heat from the compressed gas inside the cylinder very efficiently to outside the cylinder by virtue of the fact that the open matrix of the heat regenerator has a very large surface area and is in intimate thermal contact with the compressed gas and with the heat transfer gas at different times in the extended cycle, while the high heat capacity of the heat regenerator provides ample cooling of the compressed gas without itself increasing significantly in temperature. This has significant advantage compared with other known methods of attempting near-isothermal compression by cooling the cylinder from the outside with a low temperature cooling fluid, but relying on the smooth inside surface of the cylinder and piston to transfer heat out from the gas. In these known methods, the heat transfer inside the cylinder is area-limited and rate-limited, making it inefficient and inadequate to support near-isothermal compression.

In the invention, because the filling and emptying of the heat transfer gas during the extra strokes of the extended cycle take place at substantially the same pressure, the pumping work associated with these two extra strokes will be small and does not significantly affect the mechanical efficiency of the gas compressor. On the other hand, the rated delivery of the gas compressor is reduced because of the extra strokes, though the breathing efficiency during the induction stroke is improved because of more efficient gas flow and cooler gas charge.

If necessary, the sequential filling and emptying strokes may be repeated in pairs to allow the heat regenerator to give up more heat more thoroughly. Thus the reciprocating gas compressor could be operated according to an extended cycle of 4, 6 or more strokes, where the first two strokes are the working strokes for inducting and compressing the gas and the remaining pairs of strokes are the cooling strokes using more gas as heat transfer fluid for transferring heat out of the cylinder which also contains a heat regenerator acting as a cold storage.

The invention takes advantage of established technology used in the reciprocating engine field and transfers it to the gas compressor. For example, the self-actuated flapper valve conventionally used as intake in the compressor could be replaced by an externally actuated flow valve which has higher flow coefficient and the opening and closing timings are programmable according to the extended strokes and variable according to the instantaneous cylinder pressure mimicking the operation of the flapper valve.

Thus in the invention, the gas flows in and out of the cylinder during the various strokes may be programmed by appropriate timed flow valves driven by mechanical, electrical, hydraulic or pneumatic actuators and controlling the flows through corresponding ports in the cylinder. In particular, compressed gas from the compressor could be used to power the pneumatic actuators.

Preferably, the same intake valve and port for the induction stroke is used as the filling and emptying valve and port for the extra strokes, thus bringing the gas in and out of the cylinder along a common passage with the intake valve timed to remain open during the extra and induction strokes, and to close only during the compression stroke.

Preferably, additional respective one-way valves are provided in the inlet and outlet openings of the common passage to the low pressure gas source, arranged such that cold low pressure gas is drawn into the passage only through the inlet one-way valve and hot heat transfer gas is expelled out of the passage only through the outlet one-way valve.

In the invention, the low pressure gas source may be ambient air in large open space and there is no need to cool the ambient air. Alternatively, the low pressure gas source could be any gas source in a pipe system of a single stage or multi-stage gas compressor. In this case, the low pressure gas used as heat transfer fluid transferred in and out of the cylinder during the extra filling and emptying strokes may be cooled externally by a heat exchanger before it is returned to the pipe system.

In the second aspect of the invention, the reciprocating gas expander comprises at least one cylinder having a variable volume defined by a reciprocating piston which produces work when a predetermined quantity of high pressure gas serving as working fluid is admitted into the cylinder and allowed to expand against the piston to produce power during the expansion stroke, and the expanded gas is subsequently expelled from the cylinder displaced by the piston during the exhaust stroke, characterised in that the reciprocating gas expander is operated according to an extended cycle comprising after the said expansion and exhaust strokes, at least one pair of extra strokes each pair consisting of a filling stroke in which warm air or warmed expelled gas serving as heat transfer fluid is drawn by the piston into the cylinder to fill the cylinder followed immediately by an emptying stroke in which the filled gas is expelled by the piston out of the cylinder, such that the filled gas warms the cylinder and piston and raises the gas expander temperature close to the temperature of the filled gas during the extra strokes, before the extended cycle is repeated with the working fluid of fresh high pressure gas admitted into the cylinder during the next expansion stroke.

An open matrix heat regenerator constructed in fine mesh or thin wall cell structure of high heat capacity material is additionally provided occupying the clearance space in the cylinder and in intimate thermal contact with the gas inside the cylinder. The heat regenerator serves efficiently to absorb and store heat from the filled gas (heat transfer fluid) during the extra filling and emptying strokes of the extended cycle, and to release the stored heat to the expanding gas (working fluid) during the next expansion stroke.

In the invention, by using warm air or warmed expelled working fluid as heat transfer fluid to transfer external heat to the cylinder, piston and heat regenerator and raise the temperature of the cylinder and heat regenerator close to the temperature of the warm air during the extra filling and emptying strokes, the admitted working fluid of high pressure gas expanding (and potentially cooling) during the next expansion stroke will be warmed progressively by the heat regenerator and stay at substantially the same temperature as the heat regenerator, thus enabling the admitted high pressure gas in the gas expander to achieve an expansion process which is near-isothermal.

The invention supports near-isothermal expansion by relaying heat to the expanding gas inside the cylinder very efficiently from outside the cylinder by virtue of the fact that the open matrix of the heat regenerator has a very large surface area and is in intimate thermal contact with the working fluid and with the heat transfer fluid at different times in the extended cycle, while the high heat capacity of the heat regenerator provides ample heat directly to the expanding gas without itself dropping significantly in temperature. This has significant advantage compared with other known methods of attempting near-isothermal expansion by heating the cylinder from the outside but relying on the smooth inside surface of the cylinder and piston to transfer heat through to the gas. In these known methods, the heat transfer inside the cylinder is area-limited and rate-limited because of poor internal mixing, making it inefficient and inadequate to support near-isothermal expansion.

In the invention, because the filling and emptying of the heat transfer fluid during the extra strokes of the extended cycle take place at substantially ambient pressure, the pumping work associated with these two extra strokes will be small and does not significantly affect the mechanical efficiency of the gas expander.

If necessary, the sequential filling and emptying strokes may be repeated in pairs to allow the heat regenerator to soak up more ambient heat more thoroughly. Thus the reciprocating gas expander could be operated according to an extended cycle of 4, 6 or more strokes, where the first two strokes are the working strokes using the high pressure gas as working fluid to produce power and the remaining pairs of strokes are the warming strokes using warm air or warmed expelled gas as heat transfer fluid for transferring heat into the cylinder which also contains a heat regenerator acting as a heat storage.

The gas flows in and out of the cylinder during the various strokes of the extended cycle of the present invention may be programmed by appropriate timed valves driven by mechanical, electrical, hydraulic or pneumatic actuators and controlling the flows through corresponding ports in the cylinder. In particular, the available high pressure gas could be used to power the pneumatic actuators.

Preferably, the same exhaust valve and port for the exhaust stroke is used as the filling and emptying valve and port for the extra strokes, thus bringing the gas in and out of the cylinder along a common passage with the exhaust valve timed to remain open during the exhaust and extra strokes, and to close only during the expansion stroke.

Preferably, additional respective one-way valves are provided in the inlet and outlet openings of the common passage, arranged such that warm air or warmed expelled working fluid is drawn into the passage only through the inlet one-way valve and the expanded gas and used air are expelled out of the passage only through the outlet one-way valve.

To drive the expander, the admitted high pressure gas may be compressed air or gas supplied from a compressed gas storage cylinder. Alternatively the admitted high pressure gas may supplied directly from a gas compressor.

In either or both of the above aspects of the invention, the reciprocating machines could be of the piston-crank construction. Alternatively, they could be linear free piston reciprators. The gas compressor and gas expander may be used separately in one or more stages, or in combination according to a reciprocating heat engine cycle having near-isothermal compression and expansion strokes, such as a modified Ericsson cycle or a modified Stirling cycle. They may also be used in combination according to a reciprocating refrigeration cycle having near-isothermal compression and expansion strokes.

According to a third aspect of the present invention, there is provided a modified Ericsson cycle engine comprising an extended cycle reciprocating gas compressor with an in-cylinder heat regenerator for supplying compressed gas working fluid by near-isothermal compression and an extended cycle reciprocating gas expander with an in-cylinder heat regenerator for expanding the compressed gas working fluid by near-isothermal expansion to produce work.

In the invention, more gas is used as heat transfer fluid in both said gas compressor and gas expander during the extra strokes of the respective extended cycles of the compressor and expander. During engine operation, heat addition to the engine is achieved by heating the heat transfer fluid entering the gas expander, and the heat transfer fluid transferring heat to the heat regenerator in the gas expander for heating the compressed gas working fluid in the gas expander.

According to a fourth aspect of the present invention, there is provided a modified Stirling cycle engine comprising an extended cycle reciprocating gas compressor with an in-cylinder heat regenerator for supplying compressed gas working fluid by near-isothermal compression, an heat addition heat exchanger for heating the compressed gas working fluid supplied from the gas compressor, and an extended cycle reciprocating gas expander with an in-cylinder heat regenerator for expanding the heated compressed gas working fluid by near-isothermal expansion.

In the invention, a separate return connection containing a recuperative heat regenerator is provided for the expanded gas working fluid from the gas expander to be returned along the said connection to the gas compressor, and for more gas used as heat transfer fluid to be exchanged also along the said connection between the said compressor and said expander during the extra strokes of the respective extended cycles of the compressor and expander, such that the recuperative heat regenerator in the said separate return connection absorbs heat from the working fluid and heat transfer fluid when the fluids flow through it in the direction from the gas expander to the gas compressor and releases heat to the heat transfer fluid when the fluid flows through it in the direction from the gas compressor to the gas expander.

According to a fifth aspect of the present invention, there is provided a modified Stirling cycle refrigerator driven by a motor or an engine, the refrigerator comprising an extended cycle reciprocating gas compressor with an in-cylinder heat regenerator for supplying compressed gas working fluid by near-isothermal compression, and an extended cycle reciprocating gas expander with an in-cylinder heat regenerator for expanding the compressed gas working fluid by near-isothermal expansion.

In the invention, a separate return connection containing a recuperative heat regenerator is provided for the expanded gas working fluid from the gas expander to be returned along the said connection to the gas compressor, and for more gas used as heat transfer fluid to be exchanged also along the said connection between the said compressor and said expander during the extra strokes of the respective extended cycles of the compressor and expander, such that the recuperative heat regenerator in the said separate return connection releases heat to the working fluid and heat transfer fluid when the fluids flow through it in the direction from the gas expander to the gas compressor and absorbs heat from the heat transfer fluid when the fluid flows through it in the direction from the gas compressor to the gas expander.

### BRIEF DESCRIPTION OF THE DRAWINGS

The invention will now be described further, by way of example, with reference to the accompany drawings in which

FIG. 1 shows a schematic view of a reciprocating gas compressor according to the first aspect of present invention operating with ambient air in open space,

FIG. 2 shows a schematic plan view of a preferred embodiment of a heat regenerator mounted inside the gas compressor,

FIG. 3 shows a schematic plan view of an alternative embodiment of a heat regenerator mounted inside the gas compressor,

FIG. 4 shows a schematic view similar to FIG. 1 of an alternative embodiment of a reciprocating gas compressor of the invention, operating with a low pressure gas supply in a pipe system,

FIG. 5 shows a schematic view of a reciprocating gas expander according to the second aspect of the present invention operating at substantially ambient temperature,

FIG. 6 shows a schematic plan view of a preferred embodiment of a heat regenerator mounted inside the gas expander,

FIG. 7 shows a schematic plan view of an alternative embodiment of a heat regenerator mounted inside the gas expander,

FIG. 8 shows a preferred embodiment of a buffer chamber and shut-off valves for use in substitution in FIG. 5,

FIG. 9 shows a schematic view of a modified Ericsson cycle engine according to the third aspect of the present invention operating with air as working fluid and heat transfer fluid, operating in an open cycle,

FIG. 10 shows a schematic view similar to FIG. 9 of an alternative embodiment of a modified Ericsson cycle engine of the invention, with another gas as working fluid and heat transfer fluid, operating in a closed cycle,

FIG. 11 shows a schematic view similar to FIG. 9 of a further alternative embodiment of a modified Ericsson cycle engine of the invention, with air as the working fluid and heat transfer fluid, heated by burning fuel directly in the heat transfer fluid,

FIG. 12 shows a schematic view of a modified Stirling cycle engine according to the fourth aspect of the present invention operating with a sealed gas in a closed cycle system,

FIG. 13 shows a simplified schematic view of a multi-cylinder modified Stirling cycle engine of the invention comprising two sets of working pair of compressor and expander,

FIG. 14 shows a schematic view of a modified Stirling cycle refrigerator according to the fifth aspect of the present invention operating with a sealed gas in a closed cycle system, and

FIG. 15 shows a simplified schematic view of a multi-cylinder modified Stirling cycle refrigerator of the invention comprising two sets of working pair of compressor and expander.

### DETAILED DESCRIPTION OF THE PREFERRED EMBODIMENTS

In the description, numeric annotations are specific for each Figure and not carried over to other Figures.

FIG. 1 shows a reciprocating air compressor comprising at least one cylinder 100 having a variable volume defined by a reciprocating piston 120 which draws ambient air (working fluid) into the cylinder 100 during the induction stroke and compresses the air to a high pressure before the air is released through a non-return valve 160 to a high pressure air reservoir 320 during the compression stroke. The reciprocating air compressor is further equipped to operate according to an extended cycle comprising after the said induction and compression strokes, at least one pair of extra strokes each pair consisting of a filling stroke in which more ambient air (heat transfer fluid) is drawn by the piston 120 (as shown by the ingoing arrow) into the cylinder 100 to fill the cylinder 100 followed immediately by an emptying stroke in which the filled air is expelled by the piston 120 (as shown by the outgoing arrow) out of the cylinder 100 back to the ambient. In use, the filled heat transfer air cools the cylinder 100 and piston 120 and lowers the air compressor temperature close to the temperature of the filled air during the extra strokes, before the extended cycle is repeated with the working fluid of fresh air inducted into the cylinder 100 and compressed during the next compression stroke.

An open matrix heat regenerator 140 constructed in fine mesh or thin wall cell structure of high heat capacity material is also provided occupying the clearance space in the cylinder 100 and in intimate thermal contact with the gas inside the cylinder 100. The heat regenerator 140 serves efficiently to absorb and store heat from the compressed air during the compression stroke, and to release the stored heat to the filled air during the extra filling and emptying strokes of the extended cycle.

FIG. 1 shows the piston position during a filling stroke of the extended cycle when ambient air is drawn into the cylinder 100 through a one-way valve 220 along a filling port 200 controlled by an opened filling valve 180. The filling air passes through the open matrix of the heat regenerator 140 and rapidly attains equilibrium temperature with the heat regenerator 140.

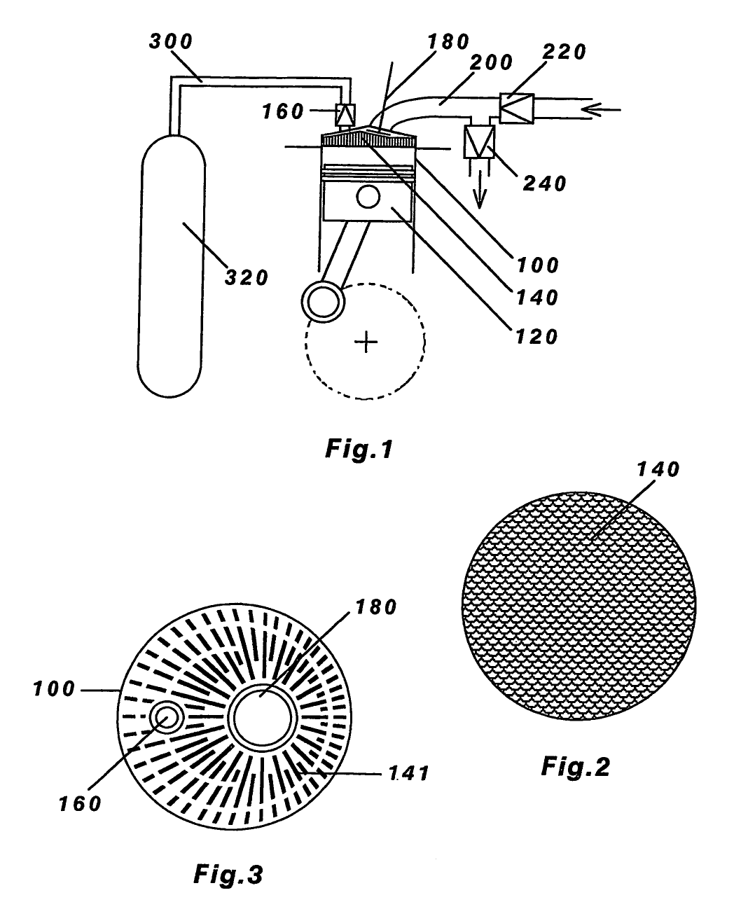

FIG. 2 shows an enlarged plan view of a preferred embodiment of the heat regenerator comprising an open matrix 140 of thin wall cell structure secured across the cylinder 100 with an unobstructed space above the matrix 140. FIG. 3 shows an enlarged plan view of an alternative embodiment of the heat regenerator comprising a dense array of fins 141 extending from the roof of the cylinder 100 and arranged radially around the filling and emptying valve 180. Another set of dense array of fins may be provided extending from the crown of the piston 120 (not shown) to serve as an additional heat regenerator overlapping into the spaces between the fins 141 in the roof of the cylinder 100 when the piston 120 approaches the top of its stroke.

The function of the heat regenerator 140 is to absorb or release heat to the air passing through it depending on the initial temperature of the air being hotter or colder than the heat regenerator 140. Because the heat regenerator 140 has a high heat capacity, it can maintain a stable mean temperature with only a small temperature variation up or down depending on the direction of heat transfer with the air passing through it, and because it has a very large heat transfer surface area, it can rapidly bring the air temperature close to the matrix mean temperature as the air exchanges heat with the matrix whatever is the initial temperature of the air.

In FIG. 1, ambient air is also used as heat transfer fluid to transfer heat away from the cylinder 100 and piston 120 and the heat regenerator 140 and lower the temperature of the cylinder 100 and heat regenerator 140 close to the temperature of the ambient air during the extra filling and emptying strokes of the extended cycle. In the subsequent compression stroke of the cycle, the working fluid air is cooled progressively by the heat regenerator 140 while being compressed and stays at substantially the same temperature as the heat regenerator 140, thus achieving a compression process which is near-isothermal.

Because the filling and emptying of the heat transfer air during the extra strokes of the extended cycle take place at substantially the same pressure, the pumping work associated with these two extra strokes will be small and does not significantly affect the mechanical efficiency of the air compressor. On the other hand, the rated delivery of the gas compressor is reduced because of the extra strokes, though the breathing efficiency during the induction stroke is improved because of more efficient gas flow and cooler gas charge.

The invention takes advantage of established technology used in the reciprocating engine field and transfers it to the gas compressor. For example, the self-actuated flapper valve conventionally used as intake in the compressor could be replaced by an externally actuated flow valve which has higher flow coefficient and the opening and closing timings are programmable according to the extended strokes and variable according to the instantaneous cylinder pressure mimicking the operation of the flapper valve.

If necessary, the sequential filling and emptying strokes may be repeated in pairs to allow the heat regenerator 140 to give up more heat more thoroughly. Thus the reciprocating air compressor could be operated according to an extended cycle of 4, 6 or more strokes, where the first two strokes are the working strokes for inducting and compressing the air and the remaining pairs of strokes are the cooling strokes using more air as heat transfer fluid for transferring heat out of the cylinder 100 which also contains a heat regenerator 140 acting as a cold storage.

The air flows in and out of the cylinder 100 during the various strokes of the extended cycle may be programmed by appropriate timed valves driven by mechanical, electrical, hydraulic or pneumatic actuators and controlling the flows through corresponding ports in the cylinder 100. In particular, compressed gas from the compressor could be used to power the pneumatic actuators.

In FIG. 1, the same intake valve 180 and port 200 for the induction stroke is used as the filling and emptying valve 180 and port 200 for the extra strokes, thus bringing the air in and out of the cylinder 100 along a common passage 200 with the intake valve 180 timed to remain open during the extra and induction strokes, and to close only during the compression stroke.

In FIG. 1, additional respective one-way valves 220, 240 are provided in the inlet and outlet openings of the common passage 200 to the ambient, arranged such that cold air is drawn into the passage 200 only through the inlet one-way valve 220 and hot air is expelled out of the passage 200 only through the outlet one-way valve 240.

In FIG. 1, the air compressor is operated with ambient air in a large open space and there is no need to cool the ambient air.

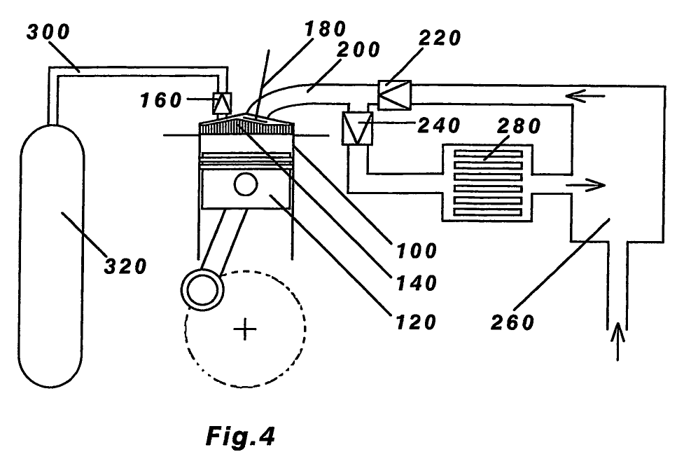

In FIG. 4, the compressor is a gas compressor drawing gas from a low pressure gas pipe system 260. In this case, the low pressure gas is also used as heat transfer fluid drawn into the cylinder 100 during the extra filling stroke of the extended cycle and expelled from the cylinder 100 during the extra emptying stroke of the extended cycle. The expelled heat transfer gas is then cooled externally by a heat exchanger 280 before it is connected back to the low pressure gas pipe system 260. This arrangement is to be used in the second stage and further stages of a two-stage or multi-stage gas compressor.

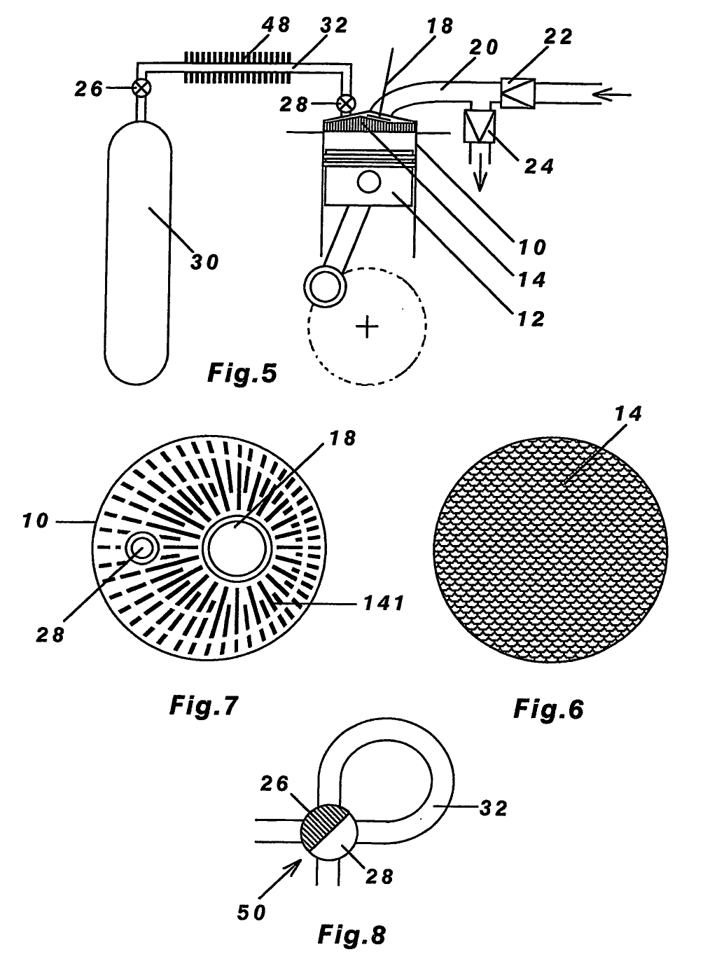

FIG. 5 shows a reciprocating gas expander comprising a cylinder 10 having a variable volume defined by a reciprocating piston 12 which produces work when a predetermined quantity of high pressure gas serving as working fluid supplied from a high pressure gas tank 30 at substantially ambient temperature is admitted into the cylinder 10 and allowed to expand against the piston 12 to produce power during the expansion stroke, and the expanded gas is subsequently expelled from the cylinder 10 displaced by the piston 12 during the exhaust stroke. The reciprocating gas expander is further equipped to operate according to an extended cycle comprising after the said expansion and exhaust strokes, at least one pair of extra strokes each pair consisting of a filling stroke in which ambient air serving as heat transfer fluid is drawn by the piston 12 (as shown by the ingoing arrow) into the cylinder 10 at substantially ambient pressure to fill the cylinder 10 followed immediately by an emptying stroke in which the filled air is expelled by the piston 12 (as shown by the outgoing arrow) at substantially ambient pressure out of the cylinder 10 back to the ambient. In use, the filled ambient air warms the cylinder 10 and piston 12 and raises the gas expander temperature close to the temperature of the filled air during the extra strokes, before the extended cycle is repeated with the working fluid of fresh high pressure gas admitted into the cylinder 10 during the next expansion stroke.

An open matrix heat regenerator 14 constructed in fine mesh or thin wall cell structure of high heat capacity material is also provided occupying the clearance space in the cylinder 10 and in intimate thermal contact with the gas or air inside the cylinder 10. The heat regenerator 14 serves efficiently to absorb and store heat from the filled ambient air (heat transfer fluid) during the extra filling and emptying strokes of the extended cycle, and to release the stored heat to the expanding gas (working fluid) during the next expansion stroke.

FIG. 5 shows the piston position during a filling stroke of the extended cycle when ambient air is drawn into the cylinder 10 through a one-way valve 22 along a filling port 20 controlled by an opened filling valve 18. The filling air passes through the open matrix of the heat regenerator 14 and rapidly attains equilibrium temperature with the heat regenerator 14.

FIG. 6 shows an enlarged plan view of the preferred embodiment of the heat regenerator comprising an open matrix 14 of thin wall cell structure secured across the cylinder 10 with an unobstructed space above the matrix 14. FIG. 7 shows an enlarged plan view of an alternative embodiment of the heat regenerator comprising a dense array of fins 141 extending from the roof of the cylinder 10 and arranged radially around the filling and emptying valve 18. Another set of dense array of fins may be provided extending from the crown of the piston 12 (not shown) to serve as an additional heat regenerator overlapping into the spaces between the fins 141 in the roof of the cylinder 10 when the piston 12 approaches the top of its stroke.

The function of the heat regenerator 14 is to absorb or release heat to the air or gas passing through it depending on the initial temperature of the air or gas being hotter or colder than the heat regenerator 14. Because the heat regenerator 14 has a high heat capacity, it can maintain a stable mean temperature with only a small temperature, variation up or down depending on the direction of heat transfer with the air or gas passing through it, and because it has a very large heat transfer surface area, it can rapidly bring the air or gas temperature close to the matrix mean temperature as the air or gas exchanges heat with the matrix whatever is the initial temperature of the air or gas.

In FIG. 5, ambient air is used as heat transfer fluid to transfer external heat to the cylinder 10 and piston 12 and the heat regenerator 14 and raise the temperature of the cylinder 10 and heat regenerator 14 close to the temperature of the ambient air during the extra filling and emptying strokes of the extended cycle. In the following expansion stroke of the cycle, the working fluid of high pressure gas is admitted into the cylinder 10 and allowed to expand (and potentially cool) while producing work, but the gas will be warmed progressively by the heat regenerator 14 and stay at substantially the same temperature as the heat regenerator 14, thus achieving an expansion process which is near-isothermal at substantially ambient temperature.

Because the filling and emptying of the heat transfer fluid during the extra strokes of the extended cycle take place at substantially ambient pressure, the pumping work associated with these two extra strokes will be small and does not significantly affect the mechanical efficiency of the gas expander. Power produced by the gas expander comes entirely from the pressure energy stored in the high pressure gas and the expander operates at a mean temperature which is close to but below ambient temperature.

If necessary, the sequential filling and emptying strokes may be repeated in pairs to allow the heat regenerator to soak up more ambient heat more thoroughly. Thus the reciprocating gas expander could be operated according to an extended cycle of 4, 6 or more strokes, where the first two strokes are the working strokes using the high pressure gas as working fluid to produce power and the remaining pairs of strokes are the warming strokes using the ambient air as heat transfer fluid for transferring heat into the cylinder 10 which also contains the heat regenerator 14 acting as a heat storage.

The gas and air flows in and out of the cylinder 10 during the various strokes of the extended cycle may be programmed by appropriate timed valves driven by mechanical, electrical, hydraulic or pneumatic actuators and controlling the flows through corresponding ports in the cylinder 10. In particular, the high pressure gas from the tank 30, could be used to power the pneumatic actuators.

In FIG. 5, the same exhaust valve 18 and port 20 for the exhaust stroke is used as the filling and emptying valve 18 and port 20 for the extra strokes, thus bringing the gas or air in and out of the cylinder 10 along a common passage 20 with the exhaust valve 18 timed to remain open during the exhaust and extra strokes, and to close only during the expansion stroke.

In FIG. 5, additional respective one-way valves 22, 24 are provided in the inlet and outlet openings of the common passage 20 to the ambient, arranged such that fresh ambient air is drawn into the passage 20 only through the inlet one-way valve 22 and the expanded gas and used ambient air are expelled out of the passage 20 only through the outlet one-way valve 24.

In FIG. 5, the admitted high pressure gas (working fluid) may be air or nitrogen gas supplied from a high pressure gas tank 30 at substantially ambient temperature.

During each cycle, the admission of a predetermined quantity of high pressure gas into the cylinder 10 of the gas expander must be timed to take place rapidly at the beginning of the expansion stroke in order to allow the gas to expand during most of the expansion stroke. This may be performed in two steps using a buffer chamber comprising at least one high pressure gas pipe 32 having a predetermined volume and connected between the high pressure gas tank 30 and the cylinder 10 by respective timed inlet and outlet shut-off valves 26, 28 synchronised with the piston strokes. In the first step, high pressure gas is admitted into the high pressure gas pipe 32 with the outlet valve 28 previously closed, by briefly opening and then closing the inlet valve 26 some time during the exhaust and extra strokes of the extended cycle. In the second step, the high pressure gas stored in high pressure gas pipe 32 is released into the cylinder 10 by opening the outlet valve 28 at the beginning of the expansion stroke and closing it some time before the inlet valve 26 is opened.

The volume of the high pressure gas pipe 32 isolated by the timed shut-off valves 26, 28 should be sufficiently small for it to be included with the expansion cylinder volume 10 of the gas expander during the expansion stroke of the gas expander, such that the high pressure gas expands from the high pressure gas pipe 32 directly into the cylinder 10 during the full expansion stroke of the gas expander and achieves a high expansion ratio relative to and including the volume of the high pressure gas pipe 32 sufficiently to bring the expanded air pressure to substantially ambient pressure at the end of the expansion stroke.

In FIG. 5, the high pressure gas pipe 32 isolated by the timed shut-off valves 26, 28 also forms part of an ambient heat exchanger 48. In this case during the expansion stroke, the expanding gas within the high pressure gas pipe 32 would continue to absorb ambient heat from the heat exchanger 48 while expanding into the cylinder 10. This is additional to the heat absorbed within the cylinder 10 from the heat regenerator 14 thus achieving in the gas an expansion process which is near-isothermal at substantially ambient temperature.

The above arrangement of timed admission of the high pressure gas performed in two steps significantly relaxes the actuation design specification of the gas expander inlet valve 28 (the same valve as the buffer chamber timed outlet shut-off valve 28) which could have more than 1800 crank angle opening period. This is to be contrasted with a conventional reciprocating gas expander connected directly to a high pressure stock gas supply, where the gas expander inlet valve must be open and closed very quickly within a very short time period while the piston is still near TDC in order to limit the high pressure gas entering the cylinder and allow it to expand with a high expansion ratio after the inlet valve is closed. Such short valve opening period poses severe problems to the design of the valve actuation system which is avoided in the present invention.

In a preferred embodiment shown in FIG. 8, the above high pressure gas pipe 32 with its inlet and outlet shut-off valves 26, 28 is designed as a compact unit 50 with the two shut-off valves combined into a multi-channel valve 26/28 actuated by a single timed actuator.

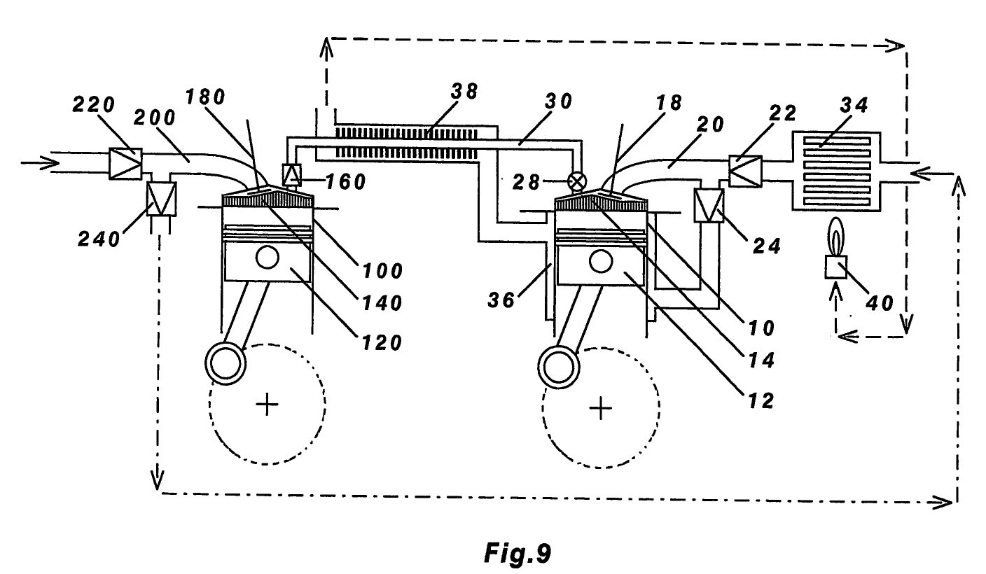

FIG. 9 shows a schematic view of a modified Ericsson cycle engine. In FIG. 9, the left hand side of the drawing shows a reciprocating air compressor similar to that shown in FIG. 1 (mirrored), the right hand side of the drawing shows a reciprocating air expander similar to that shown in FIG. 5.

In the compressor drawing, additional respective one-way valves 220, 240 are provided in the inlet and outlet openings of the common passage 200 to the outside of the compressor, arranged such that fresh ambient air is drawn into the passage 200 only through the inlet one-way valve 220 and hot heat transfer air is expelled out of the passage 200 only through the outlet one-way valve 240. This expelled heat transfer air is then passed to the air expander to be used as heat transfer fluid for the air expander.

In the expander drawing, additional respective one-way valves 22, 24 are provided in the inlet and outlet openings of the common passage 20 to the outside of the expander, arranged such that hot heat transfer air from the compressor is drawn into the passage 20 only through the inlet one-way valve 22 and the expanded working fluid air and used heat transfer air are expelled out of the passage 20 only through the outlet one-way valve 24.

In so far described, the working temperature of the air expander and the heat regenerator 14 inside it are at substantially ambient temperature which will be insufficient to sustain the thermodynamic cycle. In FIG. 9, a fuel burning heater 40 heats the heat transfer air entering the cylinder 10 through an inlet heat exchanger 34 during the extra filling stroke of the extended cycle. This constitutes the external heat addition to the Ericsson cycle engine of the present invention which is achieved by heating the heat transfer fluid entering the air expander, and the heat transfer fluid transferring heat to the heat regenerator 14 in the air expander for heating the compressed air working fluid in the air expander.

In FIG. 9, the heated heat transfer fluid heats the heat regenerator 14 in the air expander and brings the heat regenerator 14 to a high temperature in the order of 1000° K. The heat regenerator 14 in turn heats the compressed air working fluid in the air expander to substantially the same temperature which sets the upper temperature limit of the thermodynamic cycle. Obviously, the heat regenerator 14, the exhaust valve 18 and the inlet and outlet one-way valves 22, 24 should be made of suitable material such as ceramic or titanium, capable of withstanding the high operating temperature.

In FIG. 9, after transferring heat to the heat regenerator 14 inside the expander cylinder 10, the expelled heat transfer air from the outlet one-way valve 24 is still hot and is connected to a heating jacket 36 surrounding the cylinder of the air expander for heating the walls of the cylinder 10. From there the expelled air is further connected to a heat exchanger 38 for preheating the compressed air working fluid in the compressed air pipe 30 (recuperative heating) before the compressed air is admitted into the cylinder 10.

The expelled heat transfer air leaving the preheating heat exchanger 38 after heating the compressed air could still be hot and may be connected back to transfer its remaining heat to the inlet heat exchanger 34 by preheating the combustion air to the fuel burner 40 (as shown by the dashed-arrows). In this way, all additional heat is conserved within the extended cycle Ericsson engine.

In FIG. 9 with the air compressor, air expander and fuel burner constituting the extended cycle Ericsson engine, the engine comprises at least one air compressor cylinder 100 and at least one air expander cylinder 10 with their respective pistons 120, 12 connected to the same crankshaft, and phased such that the start of the compression stroke of the air compressor leads the start of the expansion stroke of the air expander by at least two complete strokes of the air expander. In the drawing, the compressor is shown leading by three complete strokes of the air expander where the compressor is at its filling stroke which is one stroke behind the compression stroke, and the expander is also at its filling stroke which is two strokes ahead of the next expansion stroke. This allows sufficient residence time (i.e. two complete strokes after the end of compression) for the compressed air from the air compressor to wait before entry to the air expander thus picking up more pre-heat more thoroughly from the preheating heat exchanger 38 before entering the air expander.

In FIG. 9, one compressor cylinder 100 is arranged to supply one expander cylinder 10 as a discrete working pair with at least one compressed air pipe 30 connecting in between uniquely provided for the working pair. The volume of the compressed air pipe 30 is sufficiently small for it to be included with the expansion cylinder volume of the air expander during the expansion stroke of the air expander, such that the compressed air expanding from the pipe 30 directly into the air expander cylinder 10 during the full expansion stroke of the air expander achieves a high expansion ratio relative to and including the volume of the pipe 30. This has the advantage that the compressed air expands immediately from the time the air expander inlet valve 28 is open, and the valve 28 can stay open during the entire expansion stroke or longer, with the pipe 30 still connected with the cylinder 10. This significantly relaxes the actuation design specification of the air expander inlet valve 28 which could have more than 1800 crank angle opening period.

The small volume of the compressed air pipe 30 provided uniquely for each working pair of compressor and expander also has other parallel functions before the compressed air is finally expanded through the air expander. Firstly, this small volume pipe 30 is the compressed air reservoir receiving air directly from the air compressor for one compression stroke of the compressor so that this pipe volume effectively sets the pressure ratio of the compressor. When taking into account the clearance volumes inside the compressor cylinder and the expander cylinder joining up with the pipe volume for each compression stroke and each expansion stroke respectively, the engine cycle will effectively have a larger expansion ratio than the compression ratio making it even more efficient in extracting useful work from the working fluid. Secondly, the compressed air pipe 30 also forms part of the heat exchanger 38 for recuperative heating so that during the expansion stroke, the expanding air within the pipe 30 would continue to absorb heat from the heat exchanger 38 while expanding into the cylinder 10. This is additional to the heat absorbed within the cylinder 10 from the heat regenerator 14 thus achieving in the air working fluid an expansion process which is near-isothermal. Thirdly, the recuperative heating mentioned earlier of this fixed volume of pipe 30 would result in heat addition to the compressed air inside the pipe 30 taking place at constant volume. This makes the present cycle in this case having attributes from both the Stirling cycle and the Ericsson cycle, the former having heat addition and heat rejection taking place at constant volume, the latter having heat addition and heat rejection taking place at constant pressure, while the present cycle having heat addition at constant volume and heat rejection at constant pressure.

Finally because the small volume in the connecting pipe 30 corresponds to the compressed air volume from one compression stroke of the air compressor to be used in one expansion stroke of the air expander within the same extended cycle of the engine, the dynamic response of the engine to changes in speed and load will be very fast. Also the start-up procedure of the engine will be quick and simple.

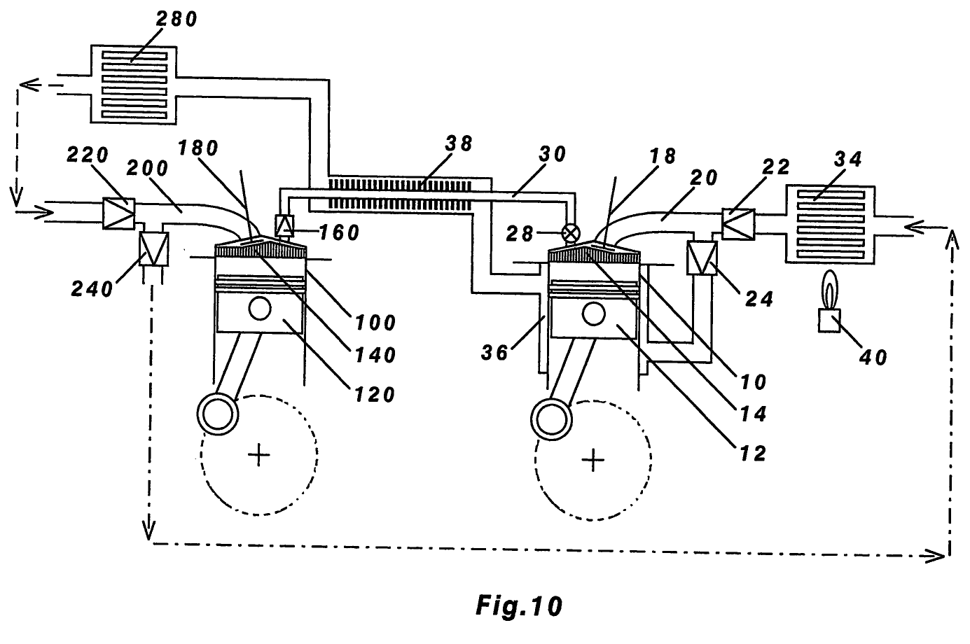

FIG. 10 shows an alternative embodiment of the present invention in which the working fluid and heat transfer fluid is another gas of low density and high thermal conductivity such as hydrogen or helium, sealed in a closed cycle system. In this case, the expelled gas from the expander is connected back to the inlet one-way valve 220 of the compressor (as shown by the dashed arrows) via a low temperature heat exchanger 280 which sets the lower temperature limit of the thermodynamic cycle.

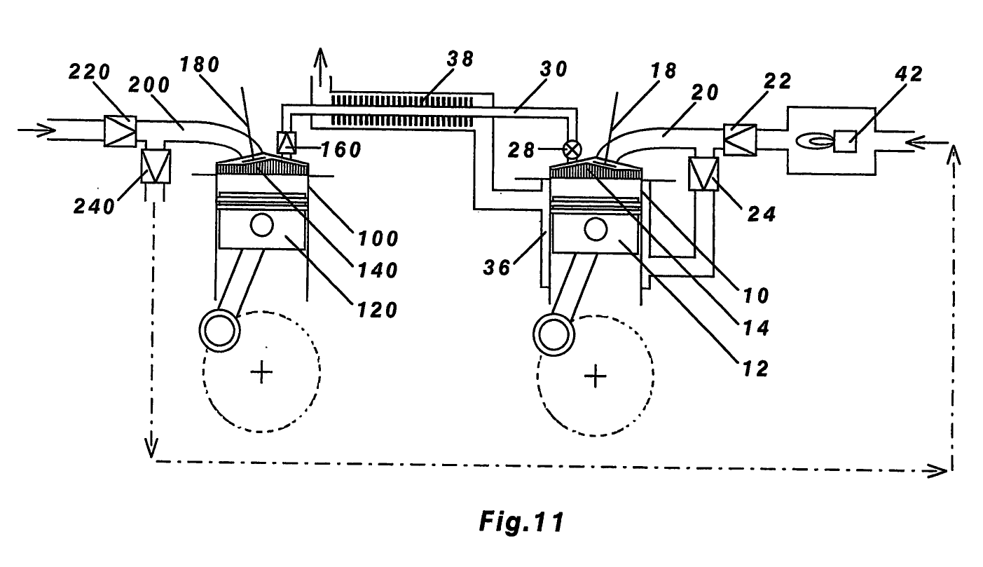

FIG. 11 shows a further alternative embodiment of the present invention in which the work fluid and heat transfer fluid is air similar to FIG. 9, but the heat addition is provided by a fuel burner 42 burning fuel directly in the heat transfer fluid air entering the expander. The burnt heat transfer gas and the expanded working fluid air are passed through the preheating heat exchanger 38 before they are finally discharged to atmosphere (as shown by the solid line arrow).

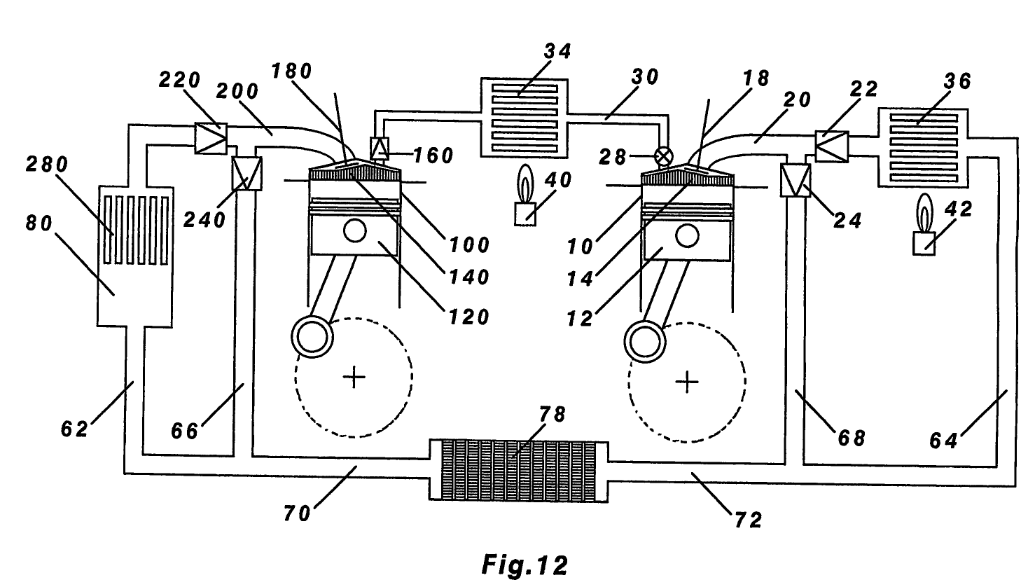

FIG. 12 shows a schematic view of a modified Stirling cycle engine. In FIG. 12, the cold side of the Stirling engine is shown on the left hand side of the drawing which includes a reciprocating gas compressor similar to that shown in FIG. 1 (mirrored), the hot side of the Stirling engine is shown on the right hand side of the drawing which includes a reciprocating air expander similar to that shown in FIG. 5.

In the compressor drawing, additional respective one-way valves 220, 240 are provided in the inlet and outlet openings of the common passage 200 to the outside of the compressor, arranged such that the gas working fluid and heat transfer fluid is drawn from the connection 68, 72, 70, 62 into the passage 200 only through the inlet one-way valve 220 and the used heat transfer fluid is expelled out of the passage 200 only through the outlet one-way valve 240 to the connection 66. The expelled heat transfer fluid is then passed to the gas expander along the connection 66, 70, 72, 64 to be used as heat transfer fluid for the gas expander.

In the expander drawing, additional respective one-way valves 22, 24 are provided in the inlet and outlet openings of the common passage 20 to the outside of the expander, arranged such that the hot gas heat transfer fluid from the compressor is drawn via the connection 66, 70, 72, 64 into the passage 20 only through the inlet one-way valve 22 and the expanded gas working fluid and used heat transfer fluid are expelled out of the passage 20 only through the outlet one-way valve 24 into the connection 68. The expelled fluids are then passed to the gas compressor along the connection 68, 72, 70, 62 to be used as working fluid and heat transfer fluid for the gas compressor.

In so far described, it is clear that there is a cyclic flow reversal of the gas working fluid and heat transfer fluid at different temperatures through the connection 70, 72, and a recuperative heat regenerator 78 placed along the connection will enable the heat content in the flow in any one direction to be transferred reversibly to the flow in the other direction. This constitutes the reversible heat recovery system of the Stirling cycle engine of the present invention, in which hot gas flowing in the direction from connection 72 to 70 will progressively decrease in temperature as it gives up heat to the heat regenerator 78, and cold gas flowing in the direction from connection 70 to 72 will progressive increase in temperature as it picks up heat from the heat regenerator 78. The heat regenerator 78 is constructed in multiple slices to inhibit heat conduction along its length, with each slice attaining an equilibrium mean temperature, decreasing in steps between the hot side and the cold side of the Stirling engine.

In FIG. 12, a fuel burning heater 40 heats the compressed gas working fluid through a heat exchanger 34 in the compressed gas transfer pipe 30 and this constitutes the external heat addition to the Stirling cycle engine of the present invention. Further heat addition may also be provided by heating the gas heat transfer fluid drawn into the gas expander by another fuel burning heater 42 heating another heat exchanger 36 in the connection 64. The heat transfer fluid transfers the additional heat to the heat regenerator 14 in the gas expander for heating the compressed gas working fluid in the gas expander during the expansion stroke.

The heat addition to the compressed gas working fluid and to the heat transfer fluid brings the gas expander to a high temperature in the order of 1000⁰K which sets the upper temperature limit of the thermodynamic cycle. Obviously, the gas expander cylinder 10, piston 12, heat regenerator 14, exhaust valve 18, inlet and outlet one-way valves 22, 24 should be made of suitable material such as ceramic or titanium, capable of withstanding the high operating temperature.

Finally in FIG. 12, a low temperature heat exchanger 280 is provided in the connection 62 for cooling the gas working fluid and heat transfer fluid drawn into the gas compressor and this constitutes the heat sink which sets the lower temperature limit of the thermodynamic cycle.

The Stirling cycle engine of the present invention may be operated with the heat sink 280 maintained at or slightly above ambient temperature, with the external heat addition to the engine provided by a hot heat source 40.

Alternatively, the engine may be operated with the heat sink 280 maintained at substantially below ambient temperature, for example at approximately 77° K., by cooling the heat sink 280 with a cryogenic liquid such as liquid nitrogen. In this case, the external heat source could be air at ambient temperature of approximately 300° K. (without any hotter heat source), and the engine will produce power efficiently operating between these temperature limits by evaporating the liquid nitrogen in the heat sink 280.

In FIG. 12 with the gas compressor, gas expander, heat source 40, heat sink 280 and recuperative heat regenerator 78 constituting the extended cycle Stirling engine of the present invention, the engine comprises at least one gas compressor cylinder 100 and at least one gas expander cylinder 10 with their respective pistons 120, 12 connected to the same crankshaft, and phased such that the start of the compression stroke of the gas compressor leads the start of the expansion stroke of the gas expander by at least two complete strokes of the gas expander. This allows ample time (i.e. at least one complete stroke after the end of compression) for the compressed gas working fluid from the gas compressor to wait briefly in the compressed gas transfer pipe 30, 34 before being admitted into the gas expander thus picking up heat from the heat addition heat exchanger 34 in the pipe 30 before entering the gas expander.

In the drawing, the compressor is shown at the beginning of the heat transfer fluid filling stroke which is one stroke behind the working fluid compression stroke, and the expander is shown also at the beginning of the heat 1o transfer fluid filling stroke which is two strokes ahead of the next working fluid expansion stroke. This allows even more time (i.e. two complete strokes after the end of compression) for the compressed gas working fluid from the gas compressor to wait in the compressed gas transfer pipe 30, 34 before being admitted into the gas expander thus picking up heat more thoroughly from the heat addition heat exchanger 34. This phasing arrangement between the compressor and expander is suitable for an opposed pistons layout which gives good balancing. This may be visualised in FIG. 12 by rotating the gas expander by 180° and aligning its crank centre with crank centre of the gas compressor.

In FIG. 12, one compressor cylinder 100 is arranged to supply one expander cylinder 10 as a discrete working pair with at least one compressed gas transfer pipe. 30 including the heat exchanger 34 connecting in between uniquely provided for the working pair. The volume of the compressed gas transfer pipe 30, 34 is sufficiently small for it to be included with the expansion cylinder volume of the gas expander during the expansion stroke of the gas expander, such that the compressed gas expanding from the pipe 30, 34 directly into the gas expander cylinder 10 during the full expansion stroke of the gas expander achieves a high expansion ratio relative to and including the volume of the pipe 30, 34. This has the advantage that the compressed gas expands immediately from the time the gas expander inlet valve 28 is open, and the valve 28 can stay open during the entire expansion stroke or longer, with the pipe 30, 34 still connected with the cylinder 10. This significantly relaxes the actuation design specification of the gas expander inlet valve 28 which could have more than 180° crank angle opening period.

The small volume of the compressed gas transfer pipe 30, 34 provided uniquely for each working pair of compressor and expander also has other parallel functions before the compressed gas is finally expanded through the gas expander. Firstly, this small volume pipe 30, 34 is the compressed gas reservoir receiving gas directly from the gas compressor for one compression stroke of the compressor so that this pipe volume effectively sets the pressure ratio of the compressor. When taking into account the clearance volumes inside the compressor cylinder and the expander cylinder joining up with the gas transfer pipe volume for each compression stroke and each expansion stroke respectively, the engine cycle will effectively operate with a larger expansion ratio than compression ratio making it even more efficient in extracting useful work from the working fluid. Secondly, the compressed gas transfer pipe 30, 34 also forms part of the heat exchanger 34 for external heat addition so that during the expansion stroke, the expanding gas within the pipe 30, 34 would continue to absorb heat from the heat exchanger 34 while expanding into the cylinder 10. This is additional to the heat absorbed within the expander cylinder 10 from the heat regenerator 14 thus achieving in the gas working fluid an expansion process which is near-isothermal. Thirdly, the external heating of the fixed volume of pipe 30, 34 during the time interval separating the compression stroke of the compressor and the expansion stroke of the expander would result in heat addition to the compressed gas inside it taking place at constant volume. This makes the Stirling cycle of the present invention very close to the ideal cycle.

Finally because the small volume in the gas transfer pipe 30, 34 corresponds to the compressed gas volume from one compression stroke of the gas compressor to be used in one expansion stroke of the gas expander within the same extended cycle of the engine, the dynamic response of the engine to changes in speed and load will be very fast. Also the start-up procedure of the engine will be quick and simple.

It should be clear in the foregoing description that, compared with a conventional Stirling cycle engine, the present invention completely eliminates the ‘dead volume’ associated with the gas transfer passage and the recuperative heat regenerator contained therein between the compressor and expander in the conventional engine. This enables the extended cycle Stirling engine of the present invention to operate at much higher compression ratio and expansion ratio which significantly improves the thermal efficiency of the engine.

Furthermore, compared with a conventional Stirling cycle engine where the gas compression, heat addition and gas expansion processes are phased close to one another with no valved separation between the compressor and expander and consequently operate with unavoidable overlap with one another, the provision of valves in the compressor and expander of the present invention and the extra time available during the extended cycles of the said compressor and expander permit clearly timed separation of the compression and expansion processes thus allowing the external heat addition to take place in between and at constant volume. This achieves a thermodynamic cycle which is very close to the ideal Stirling cycle.

Of course, the extended cycle Stirling engine of the present invention also has the benefit of near-isothermal compression and near-isothermal expansion.

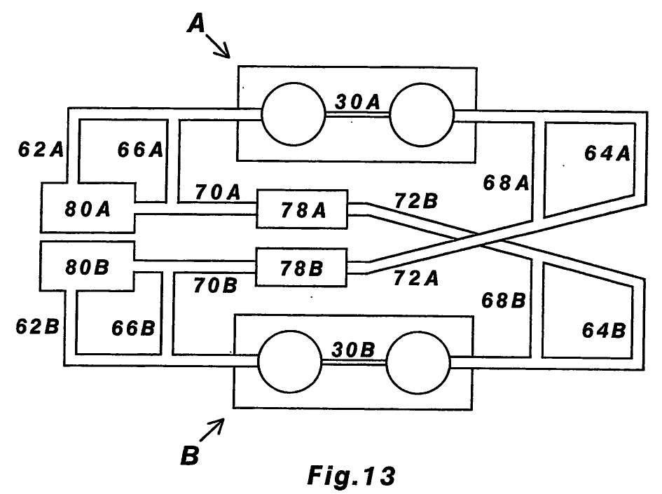

FIG. 13 shows a simplified schematic view of a multi-cylinder engine of the present invention with two sets (A and B) of working pair of compressor and expander along with their respective compressed gas transfer pipes 30A, 30B arranged to operate in opposite phase with one another. Two separate return cross-connections 62A, 66A, 70A, 72B, 68B, 64B and 62B, 66B, 70B, 72A, 68A, 64A each containing a recuperative heat regenerator 78A, 78B are provided between the compressor in one set (A or B) and the expander in the other set (B or A), thus matching the gas exchange flows between the cross-connected compressor and expander during most strokes.

Preferably a large damping volume 80A, 80B is also provided in each of the above return connections for temporarily storing any mismatch in flow arising as a consequence of the compression stroke of a compressor occurring in a different stroke to the expansion stroke of an expander. For the same reason, FIG. 12 also shows a large damping volume 80 for a single working pair of compressor and expander.

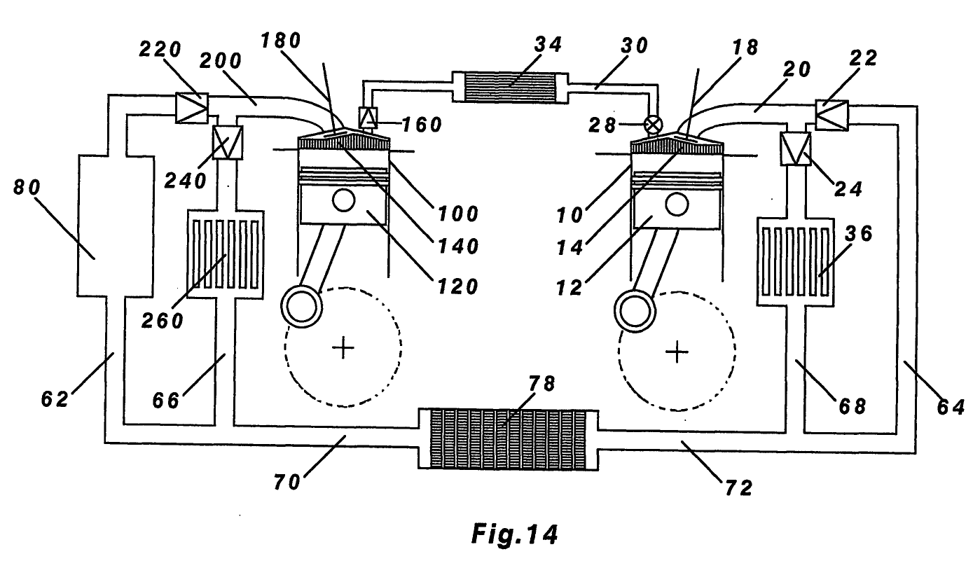

FIG. 14 shows a schematic view of a modified Stirling cycle refrigerator. In FIG. 14, the warm side of the Stirling refrigerator is shown on the left hand side of the drawing which includes a reciprocating gas compressor similar to that shown in FIG. 1 (mirrored), the cold side of the Stirling refrigerator is shown on the right hand side of the drawing which includes a reciprocating air expander similar to that shown in FIG. 5.

In the compressor drawing, additional respective one-way valves 220, 240 are provided in the inlet and outlet openings of the common passage 200 to the outside of the compressor, arranged such that the warm gas working fluid and heat transfer fluid are drawn from the connection 68, 72, 70, 62 into the passage 200 only through the inlet one-way valve 220 and the hot heat transfer fluid is expelled out of the passage 200 only through the outlet one-way valve 240 to the connection 66. The expelled hot heat transfer fluid is then passed through a heat rejection heat exchanger 260 before being connected along the connection 66, 70, 72, 64 to the gas expander to be used as heat transfer fluid in the gas expander. The heat rejection heat exchanger 260 thus sets the upper temperature limit of the thermodynamic cycle.

In the expander drawing, additional respective one-way valves 22, 24 are provided in the inlet and outlet openings of the common passage 20 to the outside of the expander, arranged such that the heat transfer fluid coming previously from the compressor is drawn via the connection 66, 70, 72, 64 into the passage 20 only through the inlet one-way valve 22 and the expanded gas working fluid and used heat transfer fluid are expelled out of the passage 20 only through the outlet one-way valve 24 into the connection 68. The expelled fluids are then passed through a chiller heat exchanger 36 before being connected along the connection 68, 72, 70, 62 back to the gas compressor to be used as working fluid and heat transfer fluid for the gas compressor. The chiller heat exchanger transfers heat from the refrigerated space to the gas working fluid and heat transfer fluid thus setting the lower temperature limit of the thermodynamic cycle.

In so far described, it is clear that there is a cyclic flow reversal of the gas working fluid and heat transfer fluid at different temperatures through the connection 70, 72, and a recuperative heat regenerator 78 placed along the connection will enable the heat content in the flow in any one direction to be transferred reversibly to the flow in the other direction. This constitutes the reversible heat recovery system of the Stirling cycle refrigerator of the present invention, in which cold gas flowing in the direction from connection 72 to 70 will progressively increase in temperature as it picks up heat from the heat regenerator 78, and warm gas flowing in the direction from connection 70 to 72 will progressive decrease in temperature as it gives up heat to the heat regenerator 78. The heat regenerator 78 is constructed in multiple slices to inhibit heat conduction along its length, with each slice attaining an equilibrium mean temperature, decreasing in steps between the warm side and the cold side of the Stirling refrigerator.

Finally, further heat rejection from the compressed gas working fluid may take place in the compressed gas transfer pipe 30 between the compressor and expander. This may be enhanced by providing another heat regenerator 34 in the compressed gas transfer pipe 30, although a plurality of small gas transfer pipes (30) may themselves have sufficient. thermal capacity and heat transfer area to serve as the heat regenerator (34).

In FIG. 14 with the gas compressor, gas expander, heat addition source 36, heat rejection sink 260 and recuperative heat regenerator 78 constituting the extended cycle Stirling refrigerator of the present invention, the refrigerator comprises at least one gas compressor cylinder 100 and at least one gas expander cylinder 10 with their respective pistons 120, 12 connected to the same crankshaft, and phased such that the start of the compression stroke of the gas compressor leads the start of the expansion stroke of the gas expander by at least two complete strokes of the gas expander. This allows ample time (i.e. at least one complete stroke after the end of compression) for the compressed gas working fluid from the gas compressor to wait briefly in the compressed gas transfer pipe 30, 34 before being admitted into the gas expander thus rejecting heat to the heat regenerator 34 in the pipe 30 before entering the gas expander.

In the drawing, the compressor is shown at the beginning of the heat transfer fluid filling stroke which is one stroke behind the working fluid compression stroke,.and the expander is shown also at the beginning of the heat transfer fluid filling stroke which is two strokes ahead of the next working fluid expansion stroke. This allows even more time (i.e. two complete strokes after the end of compression) for the compressed gas working fluid from the gas compressor to wait in the compressed gas transfer pipe 30, 34 before being admitted into the gas expander thus giving up heat progressively to the heat regenerator 34. This phasing arrangement between the compressor and expander is suitable for an opposed pistons layout which gives good balancing. This may be visualised in FIG. 14 by rotating the gas expander by 180° and aligning its crank centre with crank centre of the gas compressor.

In FIG. 14, one compressor cylinder 100 is arranged to supply one expander cylinder 10 as a discrete working pair with at least one compressed gas transfer pipe 30 including the heat regenerator 34 connecting in between uniquely provided for the working pair. The volume of the compressed gas transfer pipe 30, 34 is sufficiently small for it to be included with the expansion cylinder volume of the gas expander during the expansion stroke of the gas expander, such that the compressed gas expanding from the pipe 30, 34 directly into the gas expander cylinder 10 during the full expansion stroke of the gas expander achieves a high expansion ratio relative to and including the volume of the pipe 30, 34. This has the advantage that the compressed gas expands immediately from the time the gas expander inlet valve 28 is open, and the valve 28 can stay open during the entire expansion stroke or longer, with the pipe 30, 34 still connected with the cylinder 10. This significantly relaxes the actuation design specification of the gas expander inlet valve 28 which could have more than 180° crank angle opening period.

The small volume of the compressed gas transfer pipe 30, 34 provided uniquely for each working pair of compressor and expander also has other parallel functions before the compressed gas is finally expanded through the gas expander. Firstly, this small volume pipe 30, 34 is the compressed gas reservoir receiving gas directly from the gas compressor for one compression stroke of the compressor so that this pipe volume effectively sets the pressure ratio of the compressor. When taking into account the clearancek volumes inside the compressor cylinder and the expander cylinder joining up with the gas transfer pipe volume for each compression stroke and each expansion stroke respectively, the refrigerator cycle will effectively operate with a larger expansion ratio than compression ratio. Secondly, the compressed gas transfer pipe 30 and the heat regenerator 34 also serves as a heat capacitor during the expansion stroke so that the expanding gas within the pipe 30 would continue to absorb heat from the heat capacitor 34 while expanding into the cylinder. This is additional to the heat absorbed within the expander cylinder 10 from the in-cylinder heat regenerator 14 thus achieving in the gas working fluid an expansion process which is near-isothermal. Thirdly, the earlier heat rejection from the compressed gas to the heat regenerator 34 during the time interval separating the compression stroke of the compressor and the expansion stroke of the expander would result in heat rejection from the compressed gas inside it taking place at constant volume. All these processes would balance the heat flows into and out of the heat regenerator 34 in the pipe 30 and make the Stirling cycle of the present invention very close to the ideal cycle.

It should be clear in the foregoing description that, compared with a conventional Stirling cycle refrigerator, the present invention completely eliminates the ‘dead volume’ associated with the gas transfer passage and the recuperative heat regenerator contained therein between the compressor and expander in the conventional refrigerator. This enables the extended cycle Stirling refrigerator of the present invention to operate at much higher compression ratio and expansion ratio which significantly improves the thermal efficiency of the refrigerator.

Furthermore, compared with a conventional Stirling cycle refrigerator where the gas compression, heat addition and gas expansion processes are phased close to one another with no valved separation between the compressor and expander and consequently operate with unavoidable overlap with one another, the provision of valves in the compressor and expander of the present invention and the extra time available during the extended cycles of the said compressor and expander permit clearly timed separation of the compression and expansion processes thus allowing heat rejection from the gas to take place in between and at constant volume. This achieves a thermodynamic cycle which is very close to the ideal Stirling cycle.

Of course, the extended cycle Stirling refrigerator of the present invention also has the benefit of near-isothermal compression and near-isothermal expansion.

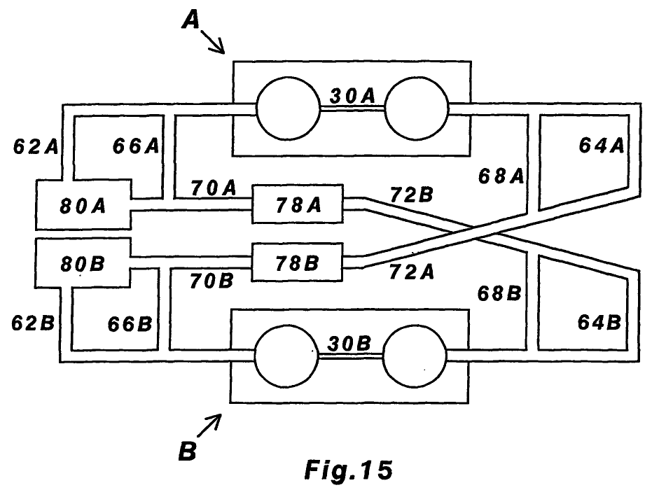

FIG. 15 shows a simplified schematic view of a multi-cylinder refrigerator of the present invention with two sets (A and B) of working pair of compressor and expander along with their respective compressed gas transfer pipes 30A, 30B arranged to operate in opposite phase with one another. Two separate return cross-connections 62A, 66A, 70A, 72B, 68B, 64B and 62B, 66B, 70B, 72A, 68A, 64A each containing a recuperative heat regenerator 78A, 78B are provided between the compressor in one set (A or B) and the expander in the other set (B or A), thus matching the gas exchange flows between the cross-connected compressor and expander during most strokes.

Preferably a large damping volume 80A, 80B is also provided in each of the above return connections for temporarily storing any mismatch in flow arising as a consequence of the compression stroke of a compressor occurring in a different stroke to the expansion stroke of an expander. For the same reason, FIG. 14 also shows a large damping volume 80 for a single working pair of compressor and expander.

The modified Stirling cycle refrigerator of the present invention may of course be used as a heat pump with the chiller heat exchanger 36 located in a chilled space and the heat rejection heat exchanger 260 located in a heated space. Both heat exchangers 36, 260 take advantage of using the gas in the system as heat transfer fluid to transport heat from one space to the other space during the extra strokes of the respective extended cycles of the expander and compressor.

1-10. (canceled)

11. A reciprocating gas compressor operated by controlling its valve timing according to an extended cycle of 4, 6 or more strokes, wherein the first two strokes are sequential induction and compression strokes using a low pressure gas as working fluid and compressing it to a high pressure gas, and the remaining strokes are pairs of sequential filling and emptying strokes using more of the low pressure gas as heat transfer fluid for transferring heat from inside the gas compressor to outside the gas compressor.

12. A reciprocating gas expander operated by controlling its valve timing according to an extended cycle of 4, 6 or more strokes, wherein the first two strokes are sequential expansion and exhaust strokes using a high pressure gas as working fluid to produce power by expansion, and the remaining strokes are pairs of sequential filling and emptying strokes using warm air or warmed expelled gas as heat transfer fluid for transferring heat from outside the expander to inside the gas expander.

13. A reciprocating gas compressor as claimed in claim 11, operating as a single stage or multi-stage gas compressor, each stage comprising at least one cylinder having a variable volume defined by a reciprocating piston 120 which draws gas (working fluid) from the an upstream gas supply into the cylinder during the induction stroke and compresses the gas to a high pressure before the gas is released to a downstream high pressure gas reservoir 320 during the compression stroke, characterized in that an open matrix heat regenerator of high heat capacity is additionally provided occupying the clearance space in the cylinder, and the reciprocating gas compressor is operated according to an extended cycle comprising after the said induction and compression strokes, at least one pair of extra strokes each pair consisting of a filling stroke in which more gas (heat transfer fluid) from the upstream gas supply is drawn by the piston into the cylinder to fill the cylinder followed immediately by an emptying stroke in which the filled gas is expelled by the piston out of the cylinder back to the upstream gas supply, such that the filled heat transfer gas cools the heat regenerator and the inside walls of the cylinder and lowers the heat regenerator temperature close to the temperature of the filled gas during the extra strokes, before the extended cycle is repeated with the working fluid of fresh gas from the upstream gas supply inducted into the cylinder and compressed while being cooled by the heat regenerator during the next compression stroke.

14. A reciprocating gas expander as claimed in claim 12, operating as a single stage or multi-stage gas expander, each stage comprising at least one cylinder having a variable volume defined by a reciprocating piston which produces work when a predetermined quantity of high pressure gas serving as working fluid is admitted into the cylinder and allowed to expand against the piston to produce power during the expansion stroke, and the expanded gas is subsequently expelled from the cylinder displaced by the piston during the exhaust stroke, characterized in that an open matrix heat regenerator of high heat capacity is additionally provided occupying the clearance space in the cylinder, and the reciprocating gas expander is operated according to an extended cycle comprising after the said expansion and exhaust strokes, at least one pair of extra strokes each pair consisting of a filling stroke in which warm air or warmed expelled gas serving as heat transfer fluid is drawn by the piston into the cylinder to fill the cylinder followed immediately by an emptying stroke in which the filled gas is expelled by the piston out of the cylinder, such that the filled gas warms the heat regenerator and the inside walls of the cylinder and raises the heat regenerator temperature close to the temperature of the filled gas during the extra strokes, before the extended cycle is repeated with the working fluid of fresh high pressure gas admitted into the cylinder, warmed by the heat regenerator while expanding to produce power during the next expansion stroke.
